(19) United States
(12) Patent Application Publication
(10) Pub. No.: US 2013/0192322 A1
(43) Pub. Date: Aug. 1, 2013

(54) Plant Fertilizers Derived from Organic Nitrogen and Phosphorus Sources

(71) Applicant: Gene W. Miller, Logan, UT (US)

(72) Inventor: Gene W. Miller, Logan, UT (US)

(21) Appl. No.: 13/565,081

(22) Filed: Aug. 2, 2012

Related U.S. Application Data
(60) Provisional application No. 61/515,195, filed on Aug. 4, 2011.

(51) Int. Cl. C05B 15/00; C05C 11/00

(52) U.S. Cl. CPC C05B 15/00; C05C 11/00
USPC 71/23

(57) ABSTRACT

Compositions and methods for the delivery of organic nitrogen and phosphorus to plants are disclosed wherein the organic nitrogen comprises an effective amount of a non-genetically modified hydrolyzed plant protein and the phosphorus comprises phytic acid. The compositions may be applied as a foliar spray or dust to the plant or to soil or water surrounding the plant.

### BACKGROUND

### Field of the Invention

This invention relates generally to non-genetically modified, enzymatically hydrolyzed plant proteins as nitrogen sources for plant fertilization; to phytic acid as an organic phosphorus source for plant fertilization and also to combinations of such hydrolyzed proteins and phytic acid for plant fertilization. More particularly this invention relates to organically derived nitrogen and phosphorus sources for plant fertilization that may be applied to water, soil or by foliar application to plants directly and which qualify as N and P sources meeting the requirements for producing, processing and handling organic foods and fiber such as are approved by organizations such as Organic Materials Review Institutes (OMRI) or Non-GMO Project's Product Verification Program (PVP). As used throughout this specification the term “non-GMO” or similar nomenclature shall mean “non-genetically modified organism” which is used as a standard in the industry.

It is customary in the fertilizer industry to identify the three primary or macro plant nutrients, nitrogen, phosphorus and potassium by the symbols NPK. These are generally reported in the literature or on packaging as NPK fertilizers. The percentage of each is reported in terms of percent N (nitrogen), percent P₂O₅ (phosphorus pentoxide) and percent K₂O (potassium oxide) even though these elements may not be present in that specific form. This application is directed primarily to the delivery of the N and P portions of fertilizers either used separately as N and P compositions or N and P combinations. However, potassium, micro-or other essential nutrients may also be added without departing from the scope of this invention.

There are those, particularly in the organic and natural foods markets, that prefer not to cultivate, use or consume plant products prepared through the use of GMO techniques including genetic engineering or recombinant DNA technologies. Regulatory, environmental and health concerns are primary reasons for using natural or organic products. As such there is a substantial market for agricultural goods that are naturally derived and produced without the aid of genetic modification of any materials utilized in the steps of growing, harvesting or otherwise processing and/or obtaining organic or natural food products.

In addition to NPK there are at least eleven other mineral micronutrients utilized for plant growth and development, calcium (Ca), magnesium (Mg), sulfur (S), iron (Fe), zinc (Zn), manganese (Mn), boron (B), copper (Cu), molybdenum (Mo), chlorine/chloride (Cl) and nickel (Ni). In organic farming it is difficult to find sources of NPK that provide these micronutrients in adequate and available form. Of course, not all micronutrients needed to be present in any given formulation. If present, any number from one to all may be present depending on plant needs and soil composition.

Most commercial N fertilizers are derived from the combination of nitrogen (from air) and hydrogen to form ammonia (NH₃) which can be used directly or as a building block for other fertilizers such as urea, ammonium nitrate, ammonium sulfate or solutions of urea and ammonium nitrate. Sodium nitrate (Chilean nitrate) is only allowed in low concentrations in organic farming due to the high sodium content. One of the problems associated with the use of such N fertilizers is environmental resulting from the incomplete utilization by the plant, retention in the soil causing leaching into and contamination of ground water, also known as eutrophication. Similar problems are associated with so-called organic nitrogen fertilizers such as sewage sludge, alfalfa, animal and poultry manures, fish products, straw and corn stalks and sawdust or wood chips. In environments in or close to human population such organic products are also undesirable due to the pungent odors they produce.

Next to nitrogen (N), phosphorus (P) is the second most limiting macronutrient required for plant growth and development. It is a component of key molecules such as nucleic acids, phospholipids and adenosine-5′-triphosphate (ATP.) Without an adequate supply of phosphorus, plants cannot grow adequately. Further, phosphorus is also involved controlling many enzymes that help to regulate many metabolic pathways in the plant. However, phosphorus is one of the least soluble mineral nutrients in the soil, often having levels in the solution phase of naturally occurring soils that is sometimes below that of many micronutrients. It is known that as much as 80% of phosphorus in soils becomes immobile and unavailable for plant uptake because of adsorption, precipitation or conversion to non-bioavailable forms. Therefore, maximum agronomic productivity is obtained only with addition of phosphorus fertilizers. However, since up to 80% of phosphorus becomes unavailable as noted above, the application of up to four times the phosphorus needed by the plant has to be applied to compensate for its unavailability. Excess phosphate excretion can lead to environmental problems such as eutrophication.

The most common source of phosphorus is obtained from the fossilized remains of ancient marine life found in rock deposits in North America, North Africa, India, Brazil and volcanic activity in China. The phosphate manufacturing process generally combines this phosphate rock with sulfuric acid to produce a concentrated phosphorus solution from which other phosphate products can be made. The most common phosphates products are triple superphosphate (0-46-0) and monoammonium phosphate (MAP) (11-52-0). Another source of phosphate is to apply rock phosphate with organic acid solubilizing agents such as gluconic acid, lactic acid, glycolic acid, fumaric acid, succinic acid and mixtures thereof. Soft rock phosphate is allowed for organic farming but, as noted above, has limited bioavailability.

Unprocessed mined minerals, such as potash (K₂O) from naturally occurring ore deposits, are acceptable sources of potassium for organic farming.

### SUMMARY OF THE INVENTION

Hydrolyzed protein as a source of nitrogen in plant nutrition has advantages not found in inorganic sources of nitrogen such as ammonium salts, amides and nitrates. The hydrolyzed protein will comprise a mixture of short chain peptides and individual L-amino acids. Such hydrolysates, when utilized as plant nutrients, serve to enhance synthesis of chlorophyll, reduce flower and fruit drop, improve rate of absorption of nitrogen and other administered fertilizers, strengthens the immune system of the plants to withstand stress caused by drought, frost, insect attack and improve the yield and quality of fruits, vegetable or other perennial crops.

Preferably the hydrolyzed proteins will have a mole weight of 400 or less and must be derived from non-genetically modified (non-GMO) sources. Furthermore, the hydrolyzed proteins must be hydrolyzed enzymatically. It is common, and often easier, to hydrolyze proteins by means of acid or base hydrolysis. Such hydrolytic methods can be harsh causing some of the hydrolysate to either decompose or revolve to a different form. For example, during acid hydrolysis amide nitrogen may be formed which, when ingested by livestock can be toxic.

For purposes of this invention the term non-GMO protein hydrolyzates or similar terminology shall mean non-GMO derived short chain peptides having a molecular weight of 400 or less as well as individual amino acids and mixtures thereof.

There is an anomaly in the use of phytic acid as a phosphorus source in plant nutrition. As noted above, phytic acid is a major source of soil phosphorus but is poorly utilized by plants. In fact, a large proportion of soil phosphorus exists as phytic acid which is secreted by plant roots. Furthermore, phytic acid is known to be inimical to the absorption of iron into plant tissues either from organic sources (ferritin-bound iron) or inorganic sources (ferrous sulfate). It has been surprisingly found that phytic acid can indeed be a profitable source of phosphorus when applied properly to plants either by foliar application or to the soil or water added to the soil.

The compositions of the present invention can be applied either as aqueous solutions or dry fertilizers. Concentrations and amounts used are those contained in state of the art compositions for NPK and applications thereof to soil, water or plants.

Since the N portion of the fertilizer is derived from enzymatically hydrolyzed non-GMO protein sources, the N content may be determined from any of various proven techniques. For example, the Kjeldahl method (AOAC, 2000) is often used to determine the N content of a protein, peptide or mixture of amino acids. The average N content of protein is often considered to be about 16% by weight. However, this may vary considerably depending upon the amount of the various amino acids making up the protein. The N content of the most commonly utilized amino acids, whether hydrophobic non polar, uncharged polar, acidic polar or basic polar will vary from about 8% w. for tyrosine to 27% w. for histidine. A commercial supplier of non-GMO hydrolyzed protein will generally list the N content of the hydrolyzate. If not, it can be determined by the Kjeldahl or similar method. In most instances it may be adequate to empirically determine how much of an enzymatically hydrolyzed non-GMO protein to utilize for any given crop or treatment.

Exact concentrations are difficult to generalize because they are to be adapted to the plants being fertilized, the soil in which they are planted, the climate, water or other environmental requirements and numerous other variables. In addition, the NPK fertilizer will most beneficially be sold with NPK concentrations of between 3 and 5% w N, 2 and 3% w P (based on P₂O₅) and 3 and 5% K based on K₂O. Micronutrients may be added as desired but will generally not comprise more than 0.1 to 3% w of the composition. At the time of application the water based fertilizer product may be diluted from about 10 to 500 or more times. A dry fertilizer product is usually available in granulated or powder form and is highly water soluble. It is generally applied to the soil in which the plant is growing or is to be grown and the amount applied calculated on the NPK content desired. For example, a dry NPK fertilizer could be diluted to about 0.01-0.5% N, 0.01-0.3% P₂O₅, and 0.01-0.5% K₂O. Powdered fertilizer may also be applied as a foliar application, e.g. as a dust.

In summary, the final product for may be applied directly to the soil around the plant as a dry fertilizer or by irrigation or solution. It may also be applied directly as a foliar application as a spray, powder or dust.

Therefore, for purposes of this disclosure the term administering to a plant an effective amount of a stated composition shall include applying directly to the plant the composition as a foliar spray or dust, or placing the composition in water or soil surrounding the plant for uptake through the plants roots. In its most basic form the composition shall include either non-GMO protein hydrolyzate or phytic acid as the primary ingredient or a combination of both non-GMO protein hydrolyzate and phytic acid as the primary ingredients. Such compositions may be administered with or without one or more other essential elements. The term effective amount shall be inclusive of all forms of composition in any desired or effective state, i.e. concentrated and/or diluted to the desired concentration consistent with the form of application.

The only limit as to which plants may be treated is one of functionality, i.e. grasses, grain crops, vegetables, fruits, ornamental trees, shrubs, flowering plants and the like may be treated.

Applications may be made at any time including the time of planting or transplanting of seeds or plants up to time of harvesting of crops such as fruits, vegetables, grasses and the like.

### EXAMPLES

In the following examples the plants were grown in a greenhouse soil mix consisting of one part by volume of each vermiculite, peat moss and soil.

### Example 1

The effect of application of a 5% nitrogen solution (5-0-0 NPK) obtained by enzymatic hydrolysis of non-genetically modified protein to tomato plants (variety Pink Girl) was determined. The tomato plants were seeded in vermiculite and transplanted into 6 inch pots of greenhouse soil mix ten days after seeding, cotyledon stage.

The experiment was arranged in a randomized design with three replicates (and the results reported are an average of the three replicates) To each pot was added two applications of a 50 ml solution of the 5-0-0 solution diluted as indicated in the following table. The solution was applied either by soil or foliar application as also indicated in the following table. The first application was applied after the first trifoliate leaves were formed about four days after transplanting and the second application was made thirteen days later. Seven days following the second application the tomato plants were harvested and the top fresh weight of each plant was recorded with the average of the three replicates of each application being given in Table 1.

TABLE 1
SUMMARY OF THE INVENTION

| Treatments | Av. Top fresh wt/plant, g | % of control |
|---|---|---|
| Control | 5.5 | 100 |
| 100× dil soil application | 7.8 | 141.8 |
| 50× dil soil application | 10.0 | 181.8 |
| 20× dil soil application | 14.6 | 265.4 |
| 100× dil foliar | 7.3 | 132.7 |
| 20× dil foliar | 8.5 | 154.5 |

As demonstrated in Table 1, all applications of nitrogen obtained from enzymatically hydrolyzed protein resulted in significant plant growth by both soil and foliar application at all degrees of dilution. The soil application was more favorable to plant growth than the foliar application in this experiment as would be expected.

### Example 2

The effect of a 3-0-3 and 3-2-3 (NPK) on tomato growth was determined as in Example 1. The tomato plants were Super Beef Steak variety. The greenhouse soil mix was used and the transplanting from vermiculite into 6″ pots was carried out as in Example 1. The applications consisted of applying 50 mls of solution at each application diluted as indicated in the Table 2 below. The 3-2-3 solution consisted of sodium nitrate (N); phytic acid (P) and potassium sulfate (K) and the 3-0-3 solution consisted of only sodium nitrate (N) and potassium sulfate (K) with no phytic acid (P) being present. Again the experiment was arranged in a randomized design with 3 replicates. All applications of the NPK and NK solutions were foliar.

As in Example 1, the tomato plants were seeded in vermiculite and transplanted into 6 inch pots of greenhouse soil mix ten days after seeding, cotyledon stage. The first application was made seven days after the first trifoliate leaf stage (about fourteen days after transplanting), a second application was made fourteen days later and a third application was made ten days following that. About seven days following the third application the tomato plants were harvested and the top fresh weight of each plant was recorded with the average of the three replicates of each application being given in Table 2.

TABLE 2

| Treatments | Av. Top fresh wt./plant, g | % of control |
|---|---|---|
| Control | 23.3 | 100 |
| 3-2-3 20× dil foliar | 37.5 | 160.9 |
| 3-2-3 50× dil foliar | 38.5 | 165.2 |
| 3-2-3 100× dil foliar | 29.5 | 126.6 |
| 3-0-3 20× dil foliar | 29.0 | 124.5 |
| 3-0-3 50× dil foliar | 30.5 | 130.9 |

As shown in Table 2, at the same dilutions, the 3-2-3 applications of mixtures containing phytic acid as the phosphorus source resulted in significantly greater tomato plant growth than the 3-0-3 application which contained no phytic acid.

### Example 3

### Effect of Enzymatically Hydrolyzed Protein and Phytic Acid on Tomato Plant Growth in Nutrient Solution

### Materials and Methods

Tomato plants (variety—Pink Girl) were grown in nutrient culture using washed perlite as a substrate. Various fertilizer compositions (1-5) listed below for NPK content were compared for nutrient value and added to a saucer, wetting the perlite in a 6″ pot. All treatments were replicated in random order 3 times. The composition nutrient solutions 1-5 were diluted 500× times and 300 ml of the selected composition solution was placed in the saucer and added to the perlite as noted. Additional nutrient solutions were added to the saucer as needed to keep the growing medium wet. Plants were harvested thirty six days after treatments were initiated.

### Compositions:

### 1. 3-2-3 (NPK)

3% Nitrogen as non-GMO hydrolyzed protein

2% P₂O₅ as phytic acid

3% K₂O as potassium sulfate

0.05% Fe as iron chelate organic acid ligand

0.05% Zn as zinc sulfate

0.05% Mn as manganese chelate organic acid ligand

0.01% B as boric acid

0.01% Cu as copper chelate organic acid ligand

2.0% S as sulfate from a mixture of Zn, Cu, Fe and Cu salts.

### 2. 3-0-3 (NPK)

Same nutrients as Composition 1 but no added phytic acid (or any other P source).

### 3. 0-2-3 (NPK)

Same nutrients as Composition 1 but no added non-GMO hydrolyzed protein (or any other N source).

### 4. 3-2-3(a) (NPK)

Same nutrients as Composition 1 except the N content of 3% was derived from sodium nitrate.

### 5. 3-2-3(b) (NPK)

Same nutrients as Composition 1 except sodium nitrate, ammonium phosphate and urea were used instead of hydrolyzed protein as the nitrogen (N) source and ammonium phosphate was used instead of phytic acid as the phosphorus (P₂O₅) source.

### Treatment Results

TABLE 3

| | Average top fresh wt. of |
|---|---|
| Composition | plants (gm) |
| 1. 3-2-3 Protein hydrolyzate and Phytic acid | 3.1 |
| 2. 0-2-3 no Nitrogen, Phytic acid | <0.1 |
| 3. 3-0-3 Protein Hydrolyzate, no Phosphorus | <0.1 |
| 4. 3-2-3(a)Nitrate Nitrogen, Phytic acid | 5.3 |
| 5. 3-2-3(b) Nitrate, Ammonium and Urea (N), | 4.5 |
| Ammonium Phosphate | |

Results in Table 3 show that when phosphorus or nitrogen was not included in the nutrient solution (Compositions 2 and 3) there was no growth of tomato plants. When 3-2-3 was included that contained phytic acid (P₂O₅) and protein hydrolyzate (N) (Composition 1) plants looked normal and weighed 3.1 grams. When a nitrate salt was used for nitrogen and phytic acid for P₂O₅ (Composition 4) plants weighed 5.3 grams. When a commercial fertilizer (Composition 5) was used for nitrogen and phosphorus plants weighed 4.5 grams.

These experiments show conclusively that tomato plants can utilize protein hydrolyzate for nitrogen (N) and phytic acid for phosphorus (P₂O₅) requirements. Furthermore, protein hydrolyzate and and phytic acid compare favorably with results obtained using conventional sources of nitrogen and phosphorus.

These results differ from Examples 1 and 2 which show positive growth even when N and P were not included in the added composition. This is due to the fact that, in Examples 1 and 2, the plants were grown in a soil mixture which inherently contained some N and P. In this Example 3 the plants were contained in a nutrient solution which, when no N or P was in the solution, showed no growth because the plant cannot grow if N and/or P is not present.

### Example 3a

### Effect of Phytic Acid and Protein Hydrolyzate on Tomato Growth Compared to Product Containing no Nitrogen

Treatment: Phytic acid and Protein Hydrolyzate (3-2-3) vs. Product with no Nitrogen (0-2-3).

### Plants Grown in Nutrient Solutions of Compositions 1 and 2

Average Top Fresh Weight of Tomato, grams

| 1. Phytic acid, | |
|---|---|
| Protein Hydrolyzate (3-2-3) | 2.Phytic acid, no Nitrogen (0-2-3) |
| 3.1 | <0.1 |

As explained above, when no protein hydrolyzate or other N source is present there can be no plant growth.

### Example 3b

### Effect of Phytic Acid and Protein Hydrolyzate on Tomato Growth Compared to Product Containing no Phosphorus

Treatment: Phytic acid and Protein Hydrolyzate (3-2-3) vs. Product with no Phosphorus (3-0-3)
Plants grown in Nutrient Solutions of Compositions 1 and 3

Average Top Fresh Weight of Tomato, grams

| 1. Phytic acid; Protein Hydrolyzate (3-2-3) | 3.Protein Hydrolyzate; No Phosphorus(3-0-3) |
|---|---|
| 3.1 | <0.1 |

As explained above, when no phytic acid or other P source is present there can be no plant growth.

### Example 3c

### Effect of Phytic Acid and Protein Hydrolyzate on Tomato Growth Compared to Common Fertilizer and Ammonium Phosphate

Treatment: Phytic acid and Protein Hydrolyzate (3-2-3) vs. Nitrogen (Urea, Nitrate, Ammonium) and Ammonium Phosphate (3-2-3(b))

### Plants Grown in Nutrient Solutions of Compositions 1 and 5.

Average Top Fresh Weight of Tomato, grams

| 1.Phytic acid, | 5. Nitrogen (Urea, Nitrate, Ammonium), |
|---|---|
| Protein Hydrolyzate (3-2-3) | Ammonium Phosphate (3-2-3(b)) |
| 3.1 | 4.5 |

As noted in Example 3, these experiments demonstrate the growth results on tomato plants utilizing protein hydrolyzate for nitrogen (N) and phytic acid for phosphorus (P₂O₅) compare favorably with results obtained using a commercial fertilizer as a source of nitrogen and phosphorus.

### Example 3d

### Effect of Phytic Acid on Tomato Growth Comparing Nitrate to Protein Hydrolyzate Nitrogen

Treatment: Phytic acid and Protein Hydrolyzate (3-2-3) vs. Nitrate Nitrogen and Phytic acid (3-2-3(a)).

### Plants Grown in Nutrient Solutions of Compositions 1 and 4.

Average Top Fresh Weight of Tomato, grams

| 1.Phytic acid, | 4. Phytic acid |
|---|---|
| Protein Hydrolyzate (3-2-3) | Nitrate Nitrogen (3-2-3(a)) |
| 3.1 | 5.3 |

As noted in Example 3, these experiments demonstrate the growth results on tomato plants utilizing protein hydrolyzate for nitrogen (N) compare favorably with results obtained using a sodium nitrate as a source of nitrogen.

### Example 4

### Protein and Phytic Acid

### Effect of Enzymatically hydrolyzed Protein and Phytic Acid on Tomato Growth (var. Pink Girl)

### Material and Methods

Tomato (var. Pink Girl) were grown in a greenhouse mix (⅓ each of components, soil, peat moss and vermiculite). The treatments were arranged in randomized design with 3 replicates for each treatment. The treatment and concentration of N, P and NP are shown in Table 4.

Seedlings were harvested and tops weighed forty six days after planting. Treatments included additions of phytic acid and protein hydrolyzate separately and in combination at different concentrations and applied to the soil and as foliar. First application, made two weeks after planting, was both as a foliar and to the soil (50 ml/plant). The second application, made two weeks following the first,) was both to soil (80 ml/plant) and as a foliar. Results are shown in Table 4:

TABLE 4

| | Av. Top fresh wt. of | |
|---|---|---|
| Treatment (Composition) | plants (gm) | % of control |
| Control | 24.7 | 100 |
| Protein Hydrolyzate | | |
| 0.15% Nitrogen, Soil application | 72.0 | 292 |
| 0.06% Nitrogen, Soil application | 55.0 | 223 |
| 0.15% Nitrogen, Foliar | 27.7 | 112 |
| 0.06% Nitrogen, Foliar | 32.0 | 130 |
| Commercial Fertilizer (Uran-32)* | | |
| 0.06% Nitrogen, Soil application | 74.7 | 302 |
| 0.06% Nitrogen, Foliar | 39.3 | 159 |
| P₂O₅, Phytic Acid | | |
| 0.1% P₂O₅, Soil application | 31.5 | 128 |
| 0.04% P₂O₅, Soil application | 27.0 | 109 |
| 0.1% P₂O₅, Foliar | 26.3 | 107 |
| 0.04% P₂O₅, Foliar | 27.0 | 109 |
| 3-2-3 with Phytic Acid and | | |
| Protein Hydrolyzate | | |
| Diluted 20×, Soil application | 94.0 | 381 |
| Diluted 50×, Soil application | 62.7 | 254 |
| Diluted 20×, Foliar | 34.7 | 141 |
| Diluted 50×, Foliar | 25.3 | 102 |

*Uran 32 is a commercial fertilizer containing 32% nitrogen derived from urea and ammonium nitrate.

The above table clearly shows the usefulness of both hydrolyzed protein and phytic acid as sources of nitrogen and phosphorus when administered separately. The data also show the advantage of using a combination of both hydrolyzed protein and phytic acid. The data also show a favorable comparison of the present invention with a commercial nitrogen fertilizer.

### Example 5

### Effect of 5-1-3 on Tomato Growth

### Product Composition: 5-1-3 (NPK)

5% Nitrogen as non-GMO hydrolyzed protein
1% P2O₅ as phytic acid
3% K₂O as potassium sulfate
0.05% Zn as zinc sulfate
0.05% Mn as manganese chelate organic acid ligand
0.01% B as boric acid
0.01% Cu as copper chelate organic acid ligand
2.0% S as sulfate

The effect of application of a 5-1-3 NPK composition with trace minerals, as noted above, on tomato plant growth was determined using Pink Girl variety of tomato plants. The tomato plants were seeded in vermiculite and transplanted into 6 inch pots of greenhouse soil mix ten days after seeding, cotyledon stage.

The treatments were arranged in a randomized design with three replicates of each treatment (and the results reported are an average of the three replicates) by either soil or foliar application and at the dilution noted in following Table 5. The control contained no added fertilizer; however, some nutrients were available from the soil mix.

To the replicates treated with a 500× dilution of the composition there was applied, depending on the plant size, 10 to 100 mls of nutrient solution daily to the soil beginning as of the day of transplanting and continuing for approximately six weeks. Treatment was discontinued about 4 days prior to harvesting.

To the replicates treated with a 50× dilution of the composition there was applied, again depending on plant size, 50 to 100 mls of nutrient solution either to the soil weekly or sprayed on all portions of the plant as a foliar spray weekly. These applications began two weeks after transplanting and continued weekly for three additional weeks. Treatment was discontinued about 4 days prior to harvesting.

About six weeks after transplanting the tomato plants were harvested and the top fresh weight of each plant was recorded with the average of the three replicates of each application being given in Table 5.

TABLE 5

| Treatments | Av. Fresh wt/plant, g | % compared to control |
|---|---|---|
| Control | 4.7 | 100 |
| 5-1-3 500× dil soil app | 40.0 | 851.1 |
| 5-1-3 50× dil soil app | 102.3 | 2176.6 |
| 5-1-3 50× dil foliar app | 18.7 | 397.9 |

These results show positive growth of a 5-1-3 composition where the nitrogen is supplied by non-GMO hydrolyzed protein and where the phosphorus is supplied by phytic acid. While soil application of product (50× dilution) at time of watering was the most effective all showed positive and significant tomato plant growth.

### Example 6

### Effect of 3-2-3 and 3-0-3 on Tomato Growth

### Product Composition: 3-2-3 and 3-0-3 (NPK)

3% Nitrogen as non-GMO hydrolyzed protein
2% P₂O₅ as phytic acid
3% K₂O as potassium sulfate
0.05% Zn as zinc sulfate
0.05% Mn as manganese chelate organic acid ligand
0.01% B as boric acid
0.01% Cu as copper chelate organic acid ligand
2.0% S as sulfate

The effect of application of 3-2-3 or 3-0-3 NPK compositions with trace minerals, as noted above, on tomato plant growth was determined using Pink Girl variety of tomato plants. The tomato plants were seeded in vermiculite and transplanted into 6 inch pots of greenhouse soil mix ten days after seeding, cotyledon stage.

The tomato plants were grown in the greenhouse in a soil mix (one-third each of soil, vermiculite and peat moss). Treatments included a 3-2-3 fertilizer where total nitrogen (3%) was supplied as a non-GMO protein hydrolysate and total phosphorus (2%) from phytic acid. A 3-0-3 composition, i.e. with no phosphorus was also used. The tomato plants were harvested about five weeks after treatments began and the tops were severed and weighed.

The treatments were arranged in a randomized design with three replicates of each treatment (and the results reported are an average of the three replicates) by either soil or foliar application and at the dilution noted in following Table 6. The control contained no added fertilizer; however, some nutrients were available from the soil mix.

When the product 3-2-3 was used (containing phytic acid and non-GMO protein hydrolyzate) a significant increase in growth was found. Less growth was found in foliar applied treatments compared to soil applications.

TABLE 6

| | Av. Top fresh wt/plant, | |
|---|---|---|
| Treatment | gms | % of control |
| Control | 17.7 | 100 |
| 3-2-3, 20× diluted, soil applied | 32.0 | 180.8 |
| 3-2-3, 50× diluted, soil applied | 36.3 | 205.1 |
| 3-2-3, 20× diluted, foliar applied | 28.3 | 159.9 |
| 3-2-3, 50× diluted, foliar applied | 38.3 | 210.7 |
| 3-0-3, 20× diluted, foliar applied | 25.0 | 141.2 |
| 3-0-3, 50× diluted, foliar applied | 23.3 | 131.6 |

As seen from Table 6, treatment compositions containing phytic acid and non-GMO protein hydrolysate as the only nitrogen and phosphorus sources had positive growth responses on tomato. The 3-2-3 product with phytic acid was superior to the 3-0-3 product showing a positive growth response when applied as a foliar spray.

### Example 7

### Effect of 5-0-0 as a Comparison Between (a) non-GMO Hydrolyzed Protein and (b) UN-32 as a Commercial Source of Nitrogen on Tomato Growth

The procedure of Example 6 was followed. Tomatoes were grown in a soil mix in the greenhouse. Treatments included the addition of either non-GMO protein hydrolysate to the soil and compared to UN-32, an inorganic nitrogen source commonly used in agriculture. Plants were harvested about four weeks after treatments began.

TABLE 7

| | Av. Top fresh | |
|---|---|---|
| Treatments | wt/plant, gms | % of control |
| Control | 7.0 | 100 |
| Protein hydrolysate (5% N) 20× diluted, | 21.0 | 300 |
| soil applied | | |
| Protein hydrolysate (5% N) 50× diluted, | 13.0 | 185.7 |
| soil applied | | |
| UN-32 (5% N) 50× diluted, soil applied | 17.5 | 250 |
| UN-32 (5% N) 100× diluted, soil applied | 11.0 | 157.1 |

The non-GMO protein hydrolysate, when applied to the soil provided a positive growth response similar to the addition of UN-32 at a similar nitrogen concentration.

The results show that nitrogen from the protein hydrolyzate was readily used as nitrogen comparable to a commonly used fertilizer containing nitrate, ammonia and urea

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods within the scope and spirit of the invention as claimed. Such embodiments may encompass different means of applying or making available to plants compositions containing effective amounts of hydrolyzed non-GMO protein as a nitrogen source, phytic acid as a phosphorus source or a mixture thereof. Such application may be done by foliar application of solutions or powders or adding such compositions to the soil surrounding the plant or to water available to the plant. Applications may be made at any time including the time of planting or transplanting of seeds or plants up to time of harvesting of crops such as fruits, vegetables, grasses and the like.

1. A composition for the delivery of nitrogen and phosphorus to plants comprising an effective amount of a non-genetically modified enzymatically hydrolyzed plant protein as a nitrogen source and an effective amount of phytic acid as a phosphorus source.

2. A composition according to claim 1 containing 1-6% w. nitrogen from the hydrolyzed plant protein.

3. A composition according to claim 2 also containing 1-5% w. phosphorus (P₂O₅) from the phytic acid.

4. A composition according to claim 1 also containing effective amounts of one or more trace elements selected from the group consisting of calcium, magnesium, sulfur, iron, zinc, manganese, boron, copper, molybdenum, chlorine and nickel.

5. A method of plant fertilization comprising administering organic nitrogen and phosphorus to a plant in the form of non-genetically modified enzymatically hydrolyzed plant protein as the nitrogen source and an effective amount of phytic acid as the phosphorus source

6. The method of claim 5 wherein the composition administered also contains effective amounts of one or more trace elements selected from the group consisting of calcium, magnesium, sulfur, iron, zinc, manganese, boron, copper, molybdenum, chlorine and nickel.

7. The method of claim 5 wherein said plant is a member selected from the group consisting of grasses, grain crops, vegetables, fruits, ornamental trees, shrubs, and flowering plants.

8. A composition for the delivery of nitrogen to plants comprising an effective amount of a non-genetically modified enzymatically hydrolyzed plant protein as a nitrogen source.

9. A composition according to claim 8 containing 1-6% w. nitrogen from the hydrolyzed plant protein.

10. A composition according to claim 8 also containing effective amounts of one or more trace elements selected from the group consisting of calcium, magnesium, sulfur, iron, zinc, manganese, boron, copper, molybdenum, chlorine and nickel.

11. A method of plant fertilization comprising administering organic nitrogen to a plant in the form of non-genetically modified enzymatically hydrolyzed plant protein as the nitrogen source.

12. The method of claim 11 wherein the composition administered also contains effective amounts of one or more trace elements selected from the group consisting of calcium, magnesium, sulfur, iron, zinc, manganese, boron, copper, molybdenum, chlorine and nickel.

13. The method of claim 12 wherein said plant is a member selected from the group consisting of grasses, grain crops, vegetables, fruits, ornamental trees, shrubs, and flowering plants.

14. A composition for the delivery of phosphorus to plants comprising an effective amount of phytic acid as a phosphorus source

15. A composition according to claim 14 containing 1-5% w. phosphorus (P₂O₅) from the phytic acid.

16. A composition according to claim 15 also containing effective amounts of one or more trace elements selected from the group consisting of calcium, magnesium, sulfur, iron, zinc, manganese, boron, copper, molybdenum, chlorine and nickel.

17. A method of plant fertilization comprising administering organic phosphorus a plant in the form of phytic acid as the phosphorus source.

18. The method of claim 17 wherein the composition administered also contains effective amounts of one or more trace elements selected from the group consisting of calcium, magnesium, sulfur, iron, zinc, manganese, boron, copper, molybdenum, chlorine and nickel.

19. The method of claim 18 wherein said plant is a member selected from the group consisting of grasses, grain crops, vegetables, fruits, ornamental trees, shrubs, and flowering plant [symbol]
